(19) United States
(12) Patent Application Publication
(10) Pub. No.: US 2004/0102529 A1
(43) Pub. Date: May 27, 2004

(54) Functionalized colloidal silica, dispersions and methods made thereby

(76) Inventors: John Robert Campbell, Clifton Park, NY (US); Slawomir Rubinsztajn, Niskayuna, NY (US); Joseph Michael Anostario, Albany, NY (US)

Correspondence Address: GENERAL ELECTRIC COMPANY, GLOBAL RESEARCH, PATENT DOCKET RM. BLDG. K1-4A59, SCHENECTADY, NY, 12301-0008, US

(21) Appl. No.: 10/301,903

(22) Filed: Nov. 22, 2002

(51) Int. Cl. B01F 17/00

(52) U.S. Cl. 516/79

(57) ABSTRACT

A composition is provided in the present invention comprising functionalized colloidal silica. The colloidal silica is functionalized with at least one organoalkoxysilane functionalization agent and subsequently functionalized with at least one capping agent. Further embodiments of the present invention include dispersions comprising the functionalized colloidal silica and methods for making.

### BACKGROUND OF THE INVENTION

The present invention is related to functionalized colloidal silica. More particularly, the present invention is related to organic dispersions of functionalized colloidal silica.

Demand for smaller and more sophisticated electronic devices continues to drive the electronic industry towards improved integrated circuits packages that are capable of supporting higher input/output (I/O) density as well as have enhanced performance at smaller die areas. Flip chip technology fulfills these demanding requirements. A weak point of the flip chip construction is the significant mechanic stress experienced by solder bumps during thermal cycling due to the coefficient of thermal expansion (CTE) mismatch between silicon die and substrate that, in turn, causes mechanical and electrical failures of the electronic devices. Currently, capillary underfill is used to fill gaps between silicon chip and substrate and improves the fatigue life of solder bumps. Unfortunately, many encapsulant compounds suffer from the inability to fill small gaps (50-100 um) between the chip and substrate due to high filler content and high viscosity of the encapsulant.

In some applications improved transparency is also needed to enable efficient dicing of a wafer to which underfill materials have been applied. In no-flow underfill applications, it is also desirable to avoid entrapment of filler particles during solder joint formulation. Thus, there remains a need to find a material that has a sufficiently low viscosity and low coefficient of thermal expansion such that it can fill small gaps between chips and substrates.

### BRIEF SUMMARY OF THE INVENTION

The present invention provides a composition comprising functionalized colloidal silica wherein the colloidal silica is functionalized with at least one organoalkoxysilane functionalization agent and subsequently functionalized with at least one capping agent.

In another embodiment, the present invention further provides an organic dispersion of colloidal silica comprising colloidal silica in the presence of at least one organoalkoxysilane functionalization agent, at least one capping agent, and at least one epoxy monomer.

In yet another embodiment, the present invention further provides a method for making a colloidal silica dispersion comprising

(A) functionalizing colloidal silica with at least one organoalkoxysilane functionalization agent in the presence of aliphatic alcohol to form a pre-dispersion;

(B) adding at least one curable epoxy monomer and optionally additional aliphatic solvent to the pre-dispersion to form a final dispersion;

(C) at least partially removing any low boiling components from the pre-dispersion or final dispersion;

(D) subsequently adding an effective amount of at least one capping agent; and

(E) substantially removing any low boiling components to form a final concentrated dispersion.

### DETAILED DESCRIPTION OF THE INVENTION

It has been found that the use of at least one epoxy resin, at least one functionalized colloidal silica, at least one cure catalyst, and optional reagents provides a curable epoxy formulation with a low viscosity of the total curable epoxy formulation before cure and whose cured parts have a low coefficient of thermal expansion (CTE). “Low coefficient of thermal expansion” as used herein refers to a cured total composition with a coefficient of thermal expansion lower than that of the base resin as measured in parts per million per degree centigrade (ppm/° C.). Typically, the coefficient of thermal expansion of the cured total composition is below about 50 ppm/° C. “Low viscosity of the total composition before cure” typically refers to a viscosity of the epoxy formulation in a range between about 50 centipoise and about 100,000 centipoise and preferably, in a range between about 100 centipoise and about 20,000 centipoise at 25° C. before the composition is cured. In another aspect of the invention, the formulated molding compound used for a transfer molding encapsulation should have viscosity in range between about 10 poise and about 5,000 poise and preferably, in range between about 50 poise and about 200 poise at molding temperature. Additionally, the above molding compound should have a spiral flow in a range between about 15 inches and about 100 inches and preferably, in range between about 25 inches and about 75 inches. “Cured” as used herein refers to a total formulation with reactive groups wherein in a range between about 50% and about 100% of the reactive groups have reacted.

Epoxy resins are curable monomers and oligomers that are blended with the functionalized colloidal silica. Epoxy resins include any organic system or inorganic system with an epoxy functionality. The epoxy resins useful in the present invention include those described in “Chemistry and Technology of the Epoxy Resins,” B. Ellis (Ed.) Chapman Hall 1993, New York and “Epoxy Resins Chemistry and Technology,” C. May and Y. Tanaka, Marcell Dekker 1972, New York. Epoxy resins that can be used for the present invention include those that could be produced by reaction of a hydroxyl, carboxyl or amine containing compound with epichlorohydrin, preferably in the presence of a basic catalyst, such as a metal hydroxide, for example sodium hydroxide. Also included are epoxy resins produced by reaction of a compound containing at least one and preferably two or more carbon-carbon double bonds with a peroxide, such as a peroxyacid.

Preferred epoxy resins for the present invention are cycloaliphatic and aliphatic epoxy resins. Aliphatic epoxy resins include compounds that contain at least one aliphatic group and at least one epoxy group. Examples of aliphatic epoxies include, butadiene dioxide, dimethylpentane dioxide, diglycidyl ether, 1,4-butanedioldiglycidyl ether, diethylene glycol diglycidyl ether, and dipentene dioxide.

Cycloaliphatic epoxy resins are well known to the art and, as described herein, are compounds that contain at least about one cycloaliphatic group and at least one oxirane group. More preferred cycloalipahtic epoxies are compounds that contain about one cycloaliphatic group and at least two oxirane rings per molecule. Specific examples include 3-cyclohexenylmethyl -3-cyclohexenylcarboxylate diepoxide, 2-(3,4-epoxy)cyclohexyl-5,5-spiro-(3,4-epoxy)cyclohexane-m-dioxane, 3,4-epoxycyclohexylalkyl-3,4-epoxycyclohexanecarboxylate, 3,4-epoxy-6-methylcyclohexylmethyl-3,4-epoxy-6-methylcyclohexanecarboxylate, vinyl cyclohexanedioxide, bis(3,4-epoxycyclohexylmethyl)adipate, bis(3,4-epoxy-6-methylcyclohexylmethyl)adipate, exo-exo bis(2,3-epoxycyclopentyl) ether, endo-exo bis(2,3-epoxycyclopentyl) ether, 2,2-bis(4-(2,3-epoxypropoxy)cyclohexyl)propane, 2,6-bis(2,3-epoxypropoxycyclohexyl-p-dioxane), 2,6-bis(2,3-epoxypropoxy)norbornene, the diglycidylether of linoleic acid dimer, limonene dioxide, 2,2-bis(3,4-epoxycyclohexyl)propane, dicyclopentadiene dioxide, 1,2-epoxy-6-(2,3-epoxypropoxy)hexahydro-4,7-methanoindane, p-(2,3-epoxy)cyclopentylphenyl-2,3-epoxypropylether, 1-(2,3-epoxypropoxy)phenyl-5,6-epoxyhexahydro-4,7-methanoindane, o-(2,3-epoxy)cyclopentylphenyl-2,3-epoxypropyl ether), 1,2-bis(5-(1,2-epoxy)-4,7-hexahydromethanoindanoxyl)ethane, cyclopentenylphenyl glycidyl ether, cyclohexanediol diglycidyl ether, and diglycidyl hexahydrophthalate. Typically, the cycloaliphatic epoxy resin is 3-cyclohexenylmethyl -3-cyclohexenylcarboxylate diepoxide.

Aromatic epoxy resins may also be used with the present invention. Examples of epoxy resins useful in the present invention include bisphenol-A epoxy resins, bisphenol-F epoxy resins, phenol novolac epoxy resins, cresol-novolac epoxy resins, biphenol epoxy resins, biphenyl epoxy resins, 4,4′-biphenyl epoxy resins, polyfunctional epoxy resins, divinylbenzene dioxide, and 2-glycidylphenylglycidyl ether. When resins, including aromatic, aliphatic and cycloaliphatic resins are described throughout the specification and claims, either the specifically-named resin or molecules having a moiety of the named resin are envisioned.

Silicone-epoxy resins of the present invention typically have the formula:

MₐM′_{b}D_{c}D′_{d}TₑT′_{f}Q_{g}

where the subscripts a, b, c, d, e, f and g are zero or a positive integer, subject to the limitation that the sum of the subscripts b, d and f is one or greater; where M has the formula:

R¹₃SiO_{1/2},

M′ has the formula:

(Z)R²₂SiO/_{1/2},

D has the formula:

R³₂SiO_{2/2},

D′ has the formula:

(Z)R⁴SiO_{2/2},

T has the formula:

R⁵SiO_{3/2},

T′ has the formula:

(Z)SiO_{3/2},

and Q has the formula SiO_{4/2}, where each R¹, R², R³R⁴, R⁵ is independently at each occurrence a hydrogen atom, C₁₋₂₂ alkyl, C₁₋₂₂ alkoxy, C₂₋₂₂ alkenyl, C₆₋₁₄ aryl, C₆₋₂₂ alkyl-substituted aryl, and C₆₋₂₂ arylalkyl which groups may be halogenated, for example, fluorinated to contain fluorocarbons such as C₁₋₂₂ fluoroalkyl, or may contain amino groups to form aminoalkyls, for example aminopropyl or aminoethylaminopropyl, or may contain polyether units of the formula (CH₂CHR⁶O)ₖ where R⁶ is CH₃ or H and k is in a range between about 4 and 20; and Z, independently at each occurrence, represents an epoxy group. The term “alkyl” as used in various embodiments of the present invention is intended to designate both normal alkyl, branched alkyl, aralkyl, and cycloalkyl radicals. Normal and branched alkyl radicals are preferably those containing in a range between about 1 and about 12 carbon atoms, and include as illustrative non-limiting examples methyl, ethyl, propyl, isopropyl, butyl, tertiary-butyl, pentyl, neopentyl, and hexyl. Cycloalkyl radicals represented are preferably those containing in a range between about 4 and about 12 ring carbon atoms. Some illustrative non-limiting examples of these cycloalkyl radicals include cyclobutyl, cyclopentyl, cyclohexyl, methylcyclohexyl, and cycloheptyl. Preferred aralkyl radicals are those containing in a range between about 7 and about 14 carbon atoms; these include, but are not limited to, benzyl, phenylbutyl, phenylpropyl, and phenylethyl. Aryl radicals used in the various embodiments of the present invention are preferably those containing in a range between about 6 and about 14 ring carbon atoms. Some illustrative non-limiting examples of these aryl radicals include phenyl, biphenyl, and naphthyl. An illustrative non-limiting example of a halogenated moiety suitable is trifluoropropyl. Combinations of epoxy monomers and oligomers may be used in the present invention.

Colloidal silica is a dispersion of submicron-sized silica (SiO₂) particles in an aqueous or other solvent medium. The colloidal silica contains up to about 85 weight % of silicon dioxide (SiO₂) and typically up to about 80 weight % of silicon dioxide. The particle size of the colloidal silica is typically in a range between about 1 nanometers (nm) and about 250 nm, and more typically in a range between about 5 nm and about 150 nm. The colloidal silica is functionalized with an organoalkoxysilane to form (via infra) an organofunctionalized colloidal silica.

Organoalkoxysilanes used to functionalize the colloidal silica are included within the formula:

(R⁷)ₐSi(OR⁸)₄₋ₐ,

where R⁷ is independently at each occurrence a C₁₋₁₈ monovalent hydrocarbon radical optionally further functionalized with alkyl acrylate, alkyl methacrylate or epoxide groups or C₆₋₁₄ aryl or alkyl radical, R⁸ is independently at each occurrence a C₁₋₁₈ monovalent hydrocarbon radical or a hydrogen radical and “a” is a whole number equal to 1 to 3 inclusive. Preferably, the organoalkoxysilanes included in the present invention are 2-(3,4-epoxy cyclohexyl)ethyltrimethoxysilane, 3-glycidoxypropyltrimethoxysilane, phenyltrimethoxysilane, and methacryloxypropyltrimethoxysilane. A combination of functionality is possible. Typically, the organoalkoxysilane is present in a range between about 5 weight % and about 60 weight % based on the weight of silicon dioxide contained in the colloidal silica. The resulting organofunctionalized colloidal silica can be treated with an acid or base to neutralize the pH. An acid or base as well as other catalysts promoting condensation of silanol and alkoxysilane groups may also be used to aid the functionalization process. Such catalyst include organo-titane and organo-tin compounds such as tetrabutyl titanate, titanium isopropoxybis(acetylacetonate), dibutyltin dilaurate, or combinations thereof.

The functionalization of colloidal silica may be performed by adding the organoalkoxysilane functionalization agent to a commercially available aqueous dispersion of colloidal silica in the weight ratio described above to which an aliphatic alcohol has been added. The resulting composition comprising the functionalized colloidal silica and the organoalkoxysilane functionalization agent in the aliphatic alcohol is defined herein as a pre-dispersion. The aliphatic alcohol may be selected from but not limited to isopropanol, t-butanol, 2-butanol, and combinations thereof. The amount of aliphatic alcohol is typically in a range between about 1 fold and about 10 fold of the amount of silicon dioxide present in the aqueous colloidal silica pre-dispersion. In some cases, stabilizers such as 4-hydroxy-2,2,6,6-tetramethylpiperidinyloxy (i.e. 4-hydroxy TEMPO) may be added to this pre-dispersion. In some instances small amounts of acid or base may be added to adjust the pH of the transparent pre-dispersion. “Transparent” as used herein refers to a maximum haze percentage of 15, typically a maximum haze percentage of 10; and most typically a maximum haze percentage of 3. The resulting pre-dispersion is typically heated in a range between about 50° C. and about 100° C. for a period in a range between about 1 hour and about 5 hours.

The cooled transparent organic pre-dispersion is then further treated to form a final dispersion of the functionalized colloidal silica by addition of curable epoxy monomers or oligomers and optionally, more aliphatic solvent which may be selected from but not limited to isopropanol, 1-methoxy-2-propanol, 1-methoxy-2-propyl acetate, toluene, and combinations thereof. This final dispersion of the functionalized colloidal silica may be treated with acid or base or with ion exchange resins to remove acidic or basic impurities. This final dispersion of the functionalized colloidal silica is then concentrated under a vacuum in a range between about 0.5 Torr and about 250 Torr and at a temperature in a range between about 20° C. and about 140° C. to substantially remove any low boiling components such as solvent, residual water, and combinations thereof to give a transparent dispersion of functionalized colloidal silica in a curable epoxy monomer, herein referred to as a final concentrated dispersion. Substantial removal of low boiling components is defined herein as removal of at least about 90% of the total amount of low boiling components.

In some instances, the pre-dispersion or the final dispersion of the functionalized colloidal silica may be further functionalized. Low boiling components are at least partially removed and subsequently, an appropriate capping agent that will react with residual hydroxyl functionality of the functionalized colloidal silica is added in an amount in a range between about 0.05 times and about 10 times the amount of silicon dioxide present in the pre-dispersion or final dispersion. Partial removal of low boiling components as used herein refers to removal of at least about 10% of the total amount of low boiling components, and preferably, at least about 50% of the total amount of low boiling components. An effective amount of capping agent caps the functionalized colloidal silica and capped functionalized colloidal silica is defined herein as a functionalized colloidal silica in which at least 10%, preferably at least 20%, more preferably at least 35%, of the free hydroxyl groups present in the corresponding uncapped functionalized colloidal silica have been functionalized by reaction with a capping agent. Capping the functionalized colloidal silica effectively improves the cure of the total curable epoxy formulation by improving room temperature stability of the epoxy formulation. Formulations which include the capped functionalized colloidal silica show much better room temperature stability than analogous formulations in which the colloidal silica has not been capped.

Exemplary capping agents include hydroxyl reactive materials such as silylating agents. Examples of a silylating agent include, but are not limited to hexamethyldisilazane (HMDZ), tetramethyldisilazane, divinyltetrametyldisilazane, diphenyltetramethyldisilazane, N-(trimethylsilyl)diethylamine, 1-(trimethylsilyl)imidazole, trimethylchlorosilane, pentamethylchlorodisiloxane, pentamethyldisiloxane, and combinations thereof. The transparent dispersion is then heated in a range between about 20° C. and about 140° C. for a period of time in a range between about 0.5 hours and about 48 hours. The resultant mixture is then filtered. If the pre-dispersion was reacted with the capping agent, at least one curable epoxy monomer is added to form the final dispersion. The mixture of the functionalized colloidal silica in the curable monomer is concentrated at a pressure in a range between about 0.5 Torr and about 250 Torr to form the final concentrated dispersion. During this process, lower boiling components such as solvent, residual water, byproducts of the capping agent and hydroxyl groups, excess capping agent, and combinations thereof are substantially removed.

In order to form the total curable epoxy formulation, a cure catalyst is added to the final concentrated dispersion. Cure catalysts accelerate curing of the total curable epoxy formulation. Typically, the catalyst is present in a range between about 10 parts per million (ppm) and about 10% by weight of the total curable epoxy formulation. Examples of cure catalysts include, but are not limited to onium catalysts such as bisaryliodonium salts (e.g. bis(dodecylphenyl)iodonium hexafluoroantimonate, (octyloxyphenyl, phenyl)iodonium hexafluoroantimonate, bisaryliodonium tetrakis(pentafluorophenyl)borate), triarylsulphonium salts, and combinations thereof. Preferably, the catalyst is a bisaryliodonium salt. Optionally, an effective amount of a free-radical generating compound can be added as the optional reagent such as aromatic pinacols, benzoinalkyl ethers, organic peroxides, and combinations thereof. The free radical generating compound facilitates decomposition of onium salt at lower temperature.

Optionally, an epoxy hardener such as carboxylic acid-anhydride curing agents and an organic compound containing hydroxyl moiety are present as optional reagents with the cure catalyst. In these cases, cure catalysts may be selected from typical epoxy curing catalysts that include but are not limited to amines, alkyl-substituted imidazole, imidazolium salts, phosphines, metal salts, and combinations thereof. A preferred catalyst is triphenyl phosphine, alkyl-imidazole, or aluminum acetyl acetonate.

Exemplary anhydride curing agents typically include methylhexahydrophthalic anhydride, 1,2-cyclohexanedicarboxylic anhydride, bicyclo[2.2.1]hept-5-ene-2,3-dicarboxylic anhydride, methylbicyclo[2.2.1]hept-5-ene-2,3-dicarboxylic anhydride, phthalic anhydride, pyromellitic dianhydride, hexahydrophthalic anhydride, dodecenylsuccinic anhydride, dichloromaleic anhydride, chlorendic anhydride, tetrachlorophthalic anhydride, and the like. Combinations comprising at least two anhydride curing agents may also be used. Illustrative examples are described in “Chemistry and Technology of the Epoxy Resins” B. Ellis (Ed.) Chapman Hall, New York, 1993 and in “Epoxy Resins Chemistry and Technology”, edited by C. A. May, Marcel Dekker, N.Y., 2nd edition, 1988.

Examples of organic compounds containing hydroxyl moiety include alkane diols and bisphenols. The alkane diol may be straight chain, branched or cycloaliphatic and may contain from 2 to 12 carbon atoms. Examples of such diols include but are not limited to ethylene glycol; propylene glycol, i.e., 1,2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and combinations of any of the foregoing. Further examples of diols include bisphenols.

Suitable bisphenols include those represented by the formula:

HO—D—OH

wherein D may be a divalent aromatic radical. At least about 50 percent of the total number of D groups are aromatic organic radicals and the balance thereof are aliphatic, alicyclic, or aromatic organic radicals. Preferably, D has the structure of the formula:

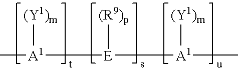

wherein A¹ represents an aromatic group such as phenylene, biphenylene, and naphthylene. E may be an alkylene or alkylidene group such as methylene, ethylene, ethylidene, propylene, propylidene, isopropylidene, butylene, butylidene, isobutylidene, amylene, amylidene, and isoamylidene. When E is an alkylene or alkylidene group, it may also consist of two or more alkylene or alkylidene groups connected by a moiety different from alkylene or alkylidene, such as an aromatic linkage; a tertiary amino linkage; an ether linkage; a carbonyl linkage; a silicon-containing linkage such as silane or siloxy; or a sulfur-containing linkage such as sulfide, sulfoxide, or sulfone; or a phosphorus-containing linkage such as phosphinyl or phosphonyl. In addition, E may be a cycloaliphatic group, such as cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, and adamantylidene. R⁹ represents hydrogen or a monovalent hydrocarbon group such as alkyl, aryl, aralkyl, alkaryl, cycloalkyl, or bicycloalkyl. The term “alkyl” is intended to designate both straight-chain alkyl and branched alkyl radicals. Straight-chain and branched alkyl radicals are preferably those containing from about 2 to about 20 carbon atoms, and include as illustrative non-limiting examples ethyl, propyl, isopropyl, butyl, tertiary-butyl, pentyl, neopentyl, hexyl, octyl, decyl, and dodecyl. Aryl radicals include phenyl and tolyl. Cyclo- or bicycloalkyl radicals represented are preferably those containing from about 3 to about 12 ring carbon atoms with a total number of carbon atoms less than or equal to about 50. Some illustrative non-limiting examples of cycloalkyl radicals include cyclobutyl, cyclopentyl, cyclohexyl, methylcyclohexyl, and cycloheptyl. Preferred aralkyl radicals are those containing from about 7 to about 14 carbon atoms; these include, but are not limited to, benzyl, phenylbutyl, phenylpropyl, and phenylethyl.

Y¹ may be a halogen, such as fluorine, bromine, chlorine, and iodine; a tertiary nitrogen group such as dimethylamino; a group such as R⁹ above, or an alkoxy group such as OR wherein R is an alkyl or aryl group. It is highly preferred that Y¹ be inert to and unaffected by the reactants and reaction conditions used to prepare the polyester carbonate. The letter “m” represents any integer from and including zero through the number of positions on A¹ available for substitution; “p” represents an integer from and including zero through the number of positions on E available for substitution; “t” represents an integer equal to at least one; “s” is either zero or one; and “u” represents any integer including zero.

In the aforementioned bisphenol in which D is represented above, when more than one Y substituent is present, they may be the same or different. For example, the Y¹ substituent may be a combination of different halogens. The R⁹ substituent may also be the same or different if more than one R⁹ substituent is present. Where “s” is zero and “u” is not zero, the aromatic rings are directly joined with no intervening alkylidene or other bridge. The positions of the hydroxyl groups and Y¹ on the aromatic nuclear residues A¹ can be varied in the ortho, meta, or para positions and the groupings can be in vicinal, asymmetrical or symmetrical relationship, where two or more ring carbon atoms of the hydrocarbon residue are substituted with Y¹ and hydroxyl groups.

Some illustrative, non-limiting examples of bisphenols include the dihydroxy-substituted aromatic hydrocarbons disclosed by genus or species in U.S. Pat. No. 4,217,438. Some preferred examples of aromatic dihydroxy compounds include 4,4′-(3,3,5-trimethylcyclohexylidene)-diphenol; 2,2-bis(4-hydroxyphenyl)propane (commonly known as bisphenol A); 2,2-bis(4-hydroxy-3,5-dimethylphenyl)propane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl)ethane; 2,2-bis(3-phenyl-4-hydroxyphenyl)propane; bis(4-hydroxyphenyl)cyclohexylmethane; 2,2-bis(4-hydroxyphenyl)-1-phenylpropane; 2,2,2′,2′-tetrahydro-3,3,3′,3′-tetramethyl-1,1′-spirobi[1H-indene]-6,6′-diol (SBI); 2,2-bis(4-hydroxy-3-methylphenyl)propane (commonly known as DMBPC); resorcinol; and C₁₋₃ alkyl-substituted resorcinols.

Most typically, 2,2-bis(4-hydroxyphenyl)propane is the preferred bisphenol compound. Combinations of organic compounds containing hydroxyl moiety can also be used in the present invention.

A reactive organic diluant may also be added to the total curable epoxy formulation to decrease the viscosity of the composition. Examples of reactive diluants include, but are not limited to, 3-ethyl-3-hydroxymethyl-oxetane, dodecylglycidyl ether, 4-vinyl-1-cyclohexane diepoxide, di(Beta-(3,4-epoxycyclohexyl)ethyl)-tetramethyldisiloxane, and combinations thereof. An unreactive diluent may also be added to the composition to decrease the viscosity of the formulation. Examples of unreactive diluants include, but are not limited to toluene, ethylacetate, butyl acetate, 1-methoxy propyl acetate, ethylene glycol, dimethyl ether, and combinations thereof. The total curable epoxy formulation can be blended with a filler which can include, for example, fumed silica, fused silica such as spherical fused silica, alumina, carbon black, graphite, silver, gold, aluminum, mica, titania, diamond, silicone carbide, aluminum hydrates, boron nitride, and combinations thereof. When present, the filler is typically present in a range between about 10 weight % and about 95 weight %, based on the weight of the total epoxy curable formulation. More typically, the filler is present in a range between about 20 weight % and about 85 weight %, based on the weight of the total curable epoxy formulation.

Adhesion promoters can also be employed with the total curable epoxy formulation such as trialkoxyorganosilanes (e.g. γ-aminopropyltrimethoxysilane, 3-glycidoxypropyltrimethoxysilane, bis(trimethoxysilylpropyl)fumarate), and combinations thereof used in an effective amount which is typically in a range between about 0.01% by weight and about 2% by weight of the total curable epoxy formulation.

Flame retardants may optionally be used in the total curable epoxy formulation of the present invention in a range between about 0.5 weight % and about 20 weight % relative to the amount of the total curable epoxy formulation. Examples of flame retardants in the present invention include phosphoramides, triphenyl phosphate (TPP), resorcinol diphosphate (RDP), bisphenol-a-disphosphate (BPA-DP), organic phosphine oxides, halogenated epoxy resin (tetrabromobisphenol A), metal oxide, metal hydroxides, and combinations thereof.

The composition of the present invention may by hand mixed but also can be mixed by standard mixing equipment such as dough mixers, chain can mixers, planetary mixers, twin screw extruder, two or three roll mill and the like.

The blending of the present invention can be performed in batch, continuous, or semi-continuous mode. With a batch mode reaction, for instance, all of the reactant components are combined and reacted until most of the reactants are consumed. In order to proceed, the reaction has to be stopped and additional reactant added. With continuous conditions, the reaction does not have to be stopped in order to add more reactants.

Formulations as described in the present invention are dispensable and have utility in devices in electronics such as computers, semiconductors, or any device where underfill, overmold, or combinations thereof is needed. Underfill encapsulant is used to reinforce physical, mechanical, and electrical properties of solder bumps that typically connect a chip and a substrate. Underfilling may be achieved by any method known in the art. The conventional method of underfilling includes dispensing the underfill material in a fillet or bead extending along two or more edges of the chip and allowing the underfill material to flow by capillary action under the chip to fill all the gaps between the chip and the substrate. Other exemplary methods include no-flow underfill, transfer molded underfill, wafer level underfill, and the like. The process of no-flow underfilling includes first dispensing the underfill encapsulant material on the substrate or semiconductor device and second performing the solder bump reflowing and underfill encapsulant curing simultaneously. The process of transfer molded underfilling includes placing a chip and substrate within a mold cavity and pressing the underfill material into the mold cavity. Pressing the underfill material fills the air spaces between the chip and substrate with the underfill material. The wafer level underfilling process includes dispensing underfill materials onto the wafer before dicing into individual chips that are subsequently mounted in the final structure via flip-chip type operations. The material has the ability to fill gaps in a range between about 30 microns and about 500 microns.

Thus, molding material to form the encapsulant is typically poured or injected into a mold form in a manner optimizing environmental conditions such as temperature, atmosphere, voltage and pressure, to minimize voids, stresses, shrinkage and other potential defects. Typically, the process step of molding the encapsulant is performed in a vacuum, preferably at a processing temperature that does not exceed about 300° C. After molding, the encapsulant is cured via methods such as thermal cure, UV light cure, microwave cure, or the like. Curing typically occurs at a temperature in a range between about 50° C. and about 250° C., more typically in a range between about 120° C. and about 225° C., at a pressure in a range between about 1 atmosphere (atm) and about 5 tons pressure per square inch, more typically in a range between about 1 atmosphere and about 1000 pounds per square inch (psi). In addition, curing may typically occur over a period in a range between about 30 seconds and about 5 hours, and more typically in a range between about 90 seconds and about 30 minutes. Optionally, the cured encapsulants can be post-cured at a temperature in a range between about 150° C. and about 250° C., more typically in range between about 175° C. and about 200° C. over a period in a range between about 1 hour and about 4 hours.

In order that those skilled in the art will be better able to practice the present invention, the following examples are given by way of illustration and not by way of limitation.

### EXAMPLES

The following section provides experimental details on the preparation of the functionalized colloidal silica samples as well as properties of epoxy formulations that incorporate these materials. The data in the following tables substantiate the assertion that an advantageous combination of reduction of Coefficient of Thermal Expansion (CTE) and preservation of material transparency can be obtained with the use of the appropriate functionalized colloidal silica. Resins with appropriate functionalized colloidal silica also permit formulation of molding compounds with acceptable spiral flow and low CTE.

The data also show that substantial improvements in the stability of initial formulation viscosity are obtained by partially or fully capping the functionalized colloidal silica by reaction with hexamethyldisilazane. The same benefit in film transparency, CTE reduction and acceptable spiral flow is also exhibited by resins based on the capped colloidal silica materials.

### Example 1

### Preparation of Functionalized Colloidal Silica Pre-Dispersion

The following general procedure was used to prepare functionalized colloidal silica pre-dispersions with the proportions of reagents given in Table 1. For example, a mixture of aqueous colloidal silica (465 grams (g); 34% silica, Nalco 1034a), isopropanol (800 g) and phenyltrimethoxy silane (56.5 g) was heated and stirred at 60-70° C. for 2 hours to give a clear suspension.

TABLE 1
Functionalized Colloidal Silica Pre-dispersions

| Entry | Isopropanol(g) | Nalco 1034(g) | Additive(g) |
|---|---|---|---|
| 1 | 546 | 403 | MAPPS* (60.4) |
| 2 | 800 | 465 | PHTS** (56.5) |
| 3 | 314 | 230 | GPTMS*** (33.0) |
| 4 | 500 | 325 | ECETS**** (53) |

*MAPPS is 3-(methacryloxy)propyltrimethoxysilane
**PHTS is phenyltrimethoxysilane
***GPTMS is 3-(glycidoxypropyl)trimethoxysilane
****ECETS is beta-(3,4-epoxycyclohexyl)ethyltrimethoxysilane

The resulting mixture was stored at room temperature.

### Example 2

### Preparation of Functionalized Colloidal Silica Dispersions

The pre-dispersion (Example 1) was blended with UVR6105 epoxy resin and UVR6000 oxetane resin from Dow Chemical Company (Tables 2, 3) and 1-methoxy-2-propanol. The mixture was vacuum stripped at 75° C. at 1 mmHg to the constant weight to yield a viscous or thixotropic fluid (Tables 2, 3).

TABLE 2

| | Run number | | | | | |
|---|---|---|---|---|---|---|
| | 1 | 2 | 3 | 4 | 5 | 6 |
| Reagents/g | | | | | | |
| Blend (table 1, | 30 | 30 | 30 | 30 | 30 | 30 |
| entry 2) | | | | | | |
| Blend (table 1, | | | | | | |
| entry 4) | | | | | | |
| 1-Methoxy-2-propanol | 30 | 30 | 30 | 30 | 30 | 30 |
| UVR6105 | 21 | 14 | 12 | 3 | 1.5 | |
| UVR6000 | | 7 | 12 | 3 | 4.5 | 6 |
| Properties | | | | | | |
| Yield/g | 27 | 26.8 | 30.4 | 11 | 11 | 11.2 |
| % of Functional CS | 22 | 22 | 21 | 45.5 | 45.4 | 47.2 |
| Viscosity at 25° C./ | TF | TF | ND | TF | TF | ND |
| cPs | | | | | | |
| Viscosity at 60° C./ | 2920* | 1450* | 410* | 5960* | 346* | 189* |
| cPs | | | | | | |

TF—Thixotropic fluid
*spindle # 52, 50 RPM

TABLE 3

| | Run number | | | | |
|---|---|---|---|---|---|
| | 7 | 8 | 9 | 10 | 11 |
| Reagents/g | | | | | |
| Pre-dispersion (table 1, entry 2) | | | 3 | 10 | 15 |
| Pre-dispersion (table 1, entry 4) | 30 | 30 | 27 | 20 | 15 |
| 1-Methoxy-2-propanol | 30 | 30 | 30 | 30 | 30 |
| UVR6105 | 6.4 | 3 | 6.4 | 6 | 6 |
| UVR6000 | | 3 | | | |
| Properties | | | | | |
| Yield/g | 11.7 | 11.4 | 11.7 | 12 | ND |
| % of Functional CS | 45.2 | 47.3 | 45.4 | 50 | 21 |
| Viscosity at 25° C./cPs | TF | ND | TF | TF | GEL |
| Viscosity at 60° C./cPs | 600 | 157 | 928 | 2360 | ND |

TF—Thixotropic fluid
*spindle # 52, 50 RPM

### Example 3a

### Preparation of Stabilized Functionalized Colloidal Silica Dispersions

A 250 milliliter (ml) flask was charged with 50 g of pre-dispersions (Example 1), 50 g of 1-methoxy-2-propanol and 0.5 g of basic resins (Table 4). The mixture was stirred at 70° C. After 1 hour the suspension was blended with 50 g of 1-methoxy-2-propanol and 2 g Celite® 545, cooled down to room temperature and filtered. The resulting dispersion of functionalized colloidal silica was blended with 12 g of UVR6105 Dow Chemical Company and vacuum stripped at 75° C. at 1 mmHg to the constant weight to yield a viscous resin (Table 4). Viscosity of the resin was measured at 25° C. immediately after synthesis and in 6 weeks.

### Example 3b

### Preparation of Stabilized Functionalized Colloidal Silica Dispersions

A 250 ml flask was charged with 50 g of pre-dispersions (Example 1), 50 g of 1-methoxy-2-propanol and 5 g of basic alumina (Table 4, Entry 16). The mixture was stirred at room temperature for 5 min. The suspension was blended with 50 g of 1-methoxy-2-propanol and 2 g Celite® 545 and filtered. The resulting dispersion of functionalized colloidal silica was blended with 12 g of UVR6105 Dow Chemical Company and vacuum stripped at 75° C. at 1 mmHg to the constant weight to yield a viscous resin (Table 4, Entry 16). Viscosity of the resin was measured at 25° C. immediately after synthesis and in 3 weeks.

### Example 3c

### Preparation of Stabilized Functionalized Colloidal Silica Dispersions

A 250 ml flask was charged with 50 g of pre-dispersions (example 1), and the desired amount of ammonia (Table 5, Entry 17, 19, 20, 21) or triethylamine (Table 5, Entry 18). The mixture was stirred at room temperature for 5 min. Next, the mixture was blended with 50 g of 1-methoxy-2-propanol and 12 g of UVR6105 Dow Chemical Company and vacuum stripped at 75C at 1 mmHg to the constant weight to yield a viscous resin. Viscosity of the resin was measured at 25° C. immediately after synthesis and in 3 weeks.

TABLE 4

| | Run number | | | | |
|---|---|---|---|---|---|
| | 12 | 13 | 14 | 15 | 16 |
| Reagents/g | | | | | |
| Pre-dispersion | 50 | 50 | 50 | 50 | 50 |
| (Table 1, entry 2) | | | | | |
| 1-Methoxy-2-propanol | 50 | 50 | 50 | 50 | 50 |
| Basic Resin | none | PVP 2% | PVP 25% | PSDVBA | Alumina |
| Amount of resin/g | | 0.5 | 0.5 | 1 | 5 |
| UVR6105 | 12 | 12 | 12 | 12 | 12 |
| Properties | | | | | |
| Yield/g | 25 | 20 | 19.5 | 18.5 | 18 |
| % of Functional CS | ND | 40 | 38.5 | 35.1 | 33.3 |
| Initial viscosity at 25° C./cPs | Soild | 4820** | 1943** | 2480** | 1620** |
| Viscosity after 6 weeks at 25 C./cPs | Solid | 237000 | 19300 | 13650 | Solid*** |

PVP 2% - Polyvinylpyridine - 2% crosslinked - Aldrich
PVP 25% - Polyvinylpyridine - 25% crosslinked - Aldrich
PSDVBA - Poly(styrene-co-divinylbenzene) amine functionalized - Aldrich
Basic Alumina - Aldrich
*spindle # 40, 5 RPM
**spindle #52, 20 RPM
***spindle # 40, 5 RPM, 3 weeks data

TABLE 5

| | Run number | | | | |
|---|---|---|---|---|---|
| | 17 | 18 | 19 | 20 | 21 |
| Reagents/g | | | | | |
| Pre-dispersion | (Table 1, | (Table 1, | (Table 1, | (Table 1, | (Table 1, |
| | entry 2) | entry 2) | entry 1) | entry 2) | entry 3) |
| | 50 | 50 | 230 | 360 | 72 |
| 1-Methoxy-2-propanol | 50 | 50 | 150 | 200 | 200 |
| Reagent | Ammonia | TEA | Ammonia | Ammonia | Ammonia |
| Amount of resin/g | 0.25 | 2 | 1.2 | 1.6 | 1.6 |
| UVR6105 | 12 | 12 | 40 | 43 | 43 |
| Properties | | | | | |
| Yield/g | 19.5 | 20.8 | 84.6 | 98.5 | 95 |
| % of Functional CS | 38.5 | 42.3 | 52.7 | 56.3 | 54.7 |
| Initial viscosity at 25° C./cPs | 4600* | 2540* | | | |
| Viscosity after 6 weeks at | 37400*** | 3820*** | | | |
| 25 C./cPs | | | | | |

Ammonia - 5 wt % solution of ammonia in water
TEA - 5 wt % solution of triethylamine in isopropanol
*spindle # 40, 5 RPM
***spindle # 40, 5 RPM, 3 weeks data

### Example 4

### Effect of Concentration of Stabilized Blend of Phenylsilane—Functionalized Colloidal Silica with Epoxy Resin on Viscosity

A 250 ml flask was charged with 50 g of pre-dispersions (Example 1, Entry 2), 50 g of 1-methoxy-2-propanol and 0.5 g of PVP 25%. The mixture was stirred at 70° C. After 1 hour the suspension was blended with 50 g of 1-methoxy-2-propanol and 2 g Celite® 545, cooled down to room temperature and filtered. The resulting dispersion of functionalized colloidal silica was blended with the desired amount of UVR6105 Dow Chemical Company and vacuum stripped at 75° C. at 1 mmHg to constant weight to yield a viscous resin (Table 6). Viscosity of the resin was measured at 25° C. immediately after synthesis and in 6 weeks.

TABLE 6

| | Run number | | | | |
|---|---|---|---|---|---|
| | 22 | 23 | 24 | 25 | 26 |
| Reagents/g | | | | | |
| Pre-dispersion (table 6, entry 2) | 50 | 50 | 50 | 50 | 50 |
| 1-Methoxy-2-propanol | 50 | 50 | 50 | 50 | 50 |
| PVP 25% | 0.5 | 0.5 | 0.5 | 0.5 | 0.5 |
| UVR6105 | 12 | 10 | 8 | 6 | 4 |
| Properties | | | | | |
| Yield/g | 19.54 | 17.62 | 16.6 | 14.4 | 12.7 |
| % of Functional CS | 38.5 | 43.2 | 51.8 | 58.3 | 68.5 |
| Initial viscosity at 25° C./cPs | 1943* | 2240* | 2470* | 7500* | 38800** |
| Initial viscosity at 60° C./cPs | 197*** | 210*** | 480*** | 1200* | 5500* |
| Viscosity after 6 weeks at 25 C./cPs | 19300** | 116500** | Solid | Solid | Solid |

PVP 25% - Polyvinylpyridine - 25% crosslinked - Aldrich
*spindle # 52, 20 RPM
**spindle #52, 10 RPM
***spindle # 40, 20 RPM

The data in Tables 4, 5, and 6 demonstrate that substantial gains in resin stability can be realized by these treatments with substantially lower and more stable viscosity being observed over the example (Table 4, run 12) where no treatment was performed. In this case the resin had solidified upon solvent removal.

### Example 5

### Functionalized Colloidal Silica Capping with Silylating Agent

Functionalized colloidal silica (FCS) dispersions (Runs: 19, 20, 21) were capped with hexamethyldisilazane (HMDZ) using two different procedures. Procedure (a) involves redissolution of the colloidal silica dispersion in a solvent followed by addition of HMDZ and subsequent evaporation of solvent to give fully capped functionalized colloidal silica. For example, FCS (Run 19) (10.0 g, 50% SiO₂) was resuspended in diglyme (10 ml) to give a clear solution. HMDZ was added (0.5g or 2.0 g) with vigorous stirring and the solution left overnight. The next day the solutions, which smelled strongly of ammonia were evaporated at 40° C. and 1 Torr to a mobile oil. Nuclear Magnetic Resonance (NMR) analysis showed increased capping for the reaction with 2g of HMDZ as evidenced by a higher ratio of trimethylsilyl groups to colloidal silica functionality (equimolar levels).

Procedure (b) involved capping of the FCS during the evaporation of the solvent. For example, the solution from Run 19 obtained after adding the aliphatic epoxide was partially concentrated to remove 180 g (amount equal to the methoxypropanol added). HMDZ (9.3 g, ca 5% of amount of SiO₂ in FCS) was added with vigorous stirring and the solution was left overnight. The next day the solution, which smelled strongly of ammonia was concentrated to a mobile oil at 40° C. and 1 Torr. NMR analysis showed somewhat lower capping as evidenced by a 0.5:1 molar ratio of trimethylsilyl groups to colloidal silica functionality (Table 7).

TABLE 7

| | | Capping | Extent of | |
|---|---|---|---|---|
| Run# | FCS from Run # | procedure | capping* | Yield (g) |
| 27 | 19 | B | Ca 50 | 86.0 |
| 28 | 20 | B | Ca 45 | 98.5 |
| 29 | 21 | B | Ca 60 | 95.0 |

*Based on the maximum value of 1:1 observed for trimethylsilyl to silane functionalization agent. For example 50% capping means a ratio 0.5:1 for trimethylsilyl to silane functionalization agent.

The data in Table 7 demonstrate that substantial capping of the colloidal silica can be achieved by procedure B.

### Example 6

### Capping of Functionalized Colloidal Silica with Silylating Agent

A round bottom flask was charged with pre-dispersions (Example 1, entry 2) and 1-methoxy-2-propanol. 50wt % of the total mixture was distilled off at 60° C. @ 50 Torr. The desired amount of hexamethyldisilazane was added drop-wise to the concentrated dispersion of functionalized colloidal silica. The mixture was stirred at 70° C. for 1 hour. After 1 hour Celite®545 was added to the flask, the mixture was cooled down to room temperature and filtered. The clear dispersion of functionalized colloidal silica was blended with UVR6105 Dow Chemical Company and vacuum stripped at 75° C. at 1 mmHg to the constant weight to yield a viscous resin (Table 8). Viscosity of the resin was measured at 25° C. immediately after synthesis and after 2 weeks of storage at 40° C.

TABLE 8

| | Run number | | | | | | |
|---|---|---|---|---|---|---|---|
| | 30 | 31 | 32 | 33 | 34 | 35 | 36 |
| Reagents/g | | | | | | | |
| Pre-dispersion | 100 | 200 | 50 | 50 | 200 | 50 | 200 |
| (table 1, entry 2) | | | | | | | |
| 1-Methoxy-2-propanol | 100 | 200 | 50 | 50 | 200 | 50 | 200 |
| HMDZ | 5 | 10 | 5 | 2.5 | 10 | 2.5 | 10 |
| Celite 545 | 5 | 10 | 5 | 2 | 10 | 2 | 10 |
| UVR6105 | 40 | 50 | 10 | 10 | 32 | 6 | 20 |
| Properties | | | | | | | |
| Yield/g | 56.8 | 85.6 | 17.8 | 18.6 | 64.9 | 15.6 | 53.6 |
| % of Functional CS | 29.6 | 41.6 | 44 | 46.2 | 50 | 61 | 63 |
| Initial viscosity | 659** | 1260** | 1595** | 1655** | 4290** | 15900*** | 30100*** |
| at 25° C./cPs | | | | | | | |
| Initial viscosity | | | | | | 1340** | 7050*** |
| at 60° C./cPs | | | | | | | |
| Viscosity 25° C./cPs* | | | 1460** | 1665** | | | |

HMDZ - hexamethyldisilazane - Aldrich
*after two weeks storage at 40 C.
**spindle #52, 10 RPM
***spindle # 52, 1 RPM

### Example 7

### Capping of Functionalized Colloidal Silica Capping with Silylating Agent

A round bottom flask was charged with pre-dispersions (Example 1, entry 2 and 4) and 1-methoxy-2-propanol. Next, 50wt % of the total mixture was distilled off at 60° C. at 50 Torr. The desire amount of hexamethyldisilazane was added drop-wise to the concentrated dispersion of functionalized colloidal silica. The mixture was stirred at 70° C. for 1 hour. After 1 hour Celite® 545 was added to the flask, the mixture was cool down to room temperature and filtered. The clear dispersion of functionalized colloidal silica was blended with UVR6105 Dow Chemical Company and vacuum stripped at 75° C. at 1 mmHg to the constant weight to yield a viscous resin (Table 9). Viscosity of the resin was measured at 25° C. immediately after synthesis and after 2 weeks of storage at 40° C.

TABLE 9

| Run number | 30 | 37 | 38 |
|---|---|---|---|
| Reagents/g | | | |
| Pre-dispersion (table 1, entry 4) | | 20 | 50 |
| Pre-dispersion (table 1, entry 2) | 100 | 80 | 50 |
| 1-Methoxy-2-propanol | 100 | 100 | 50 |
| HMDZ | 5 | 5 | 5 |
| Celite 545 | 5 | 5 | 5 |
| UVR6105 | 40 | 40 | 40 |
| Properties | | | |
| Yield/g | 56.8 | 57.3 | 57.07 |
| % of Functional CS | 29.6 | 30.1 | 29.9 |
| Initial viscosity at 25 C./cPs | 659* | 940* | 22400** |
| Initial viscosity at 60 C./cPs | | | 710* |

HMDZ - hexamethyldisilazane - Aldrich
*spindle #52, 10 RPM
**spindle #52, 1 RPM

### Example 8

### Preparation of Total Curable Epoxy Formulations

Epoxy test formulations were prepared in two different methods. Materials using conventional fused silica were prepared by adding UVR6105 (2.52 g) to 4-methylhexahydrophthalic anhydride (2.2 g) followed by bisphenol A (0.45 g). The suspension was heated to dissolve the BPA and aluminum acetylacetonate (0.1 g) was then added followed by reheating to dissolve the catalyst. Fused silica (2.3 g, Denka FS-5LDX) was added and the suspension stirred to disperse the filler. The resultant dispersion was cured at 150-170° C. for 3 hours.

Epoxy test formulations using FCS (Table 10) were prepared by adding aluminum acetylacetonate or triphenylphosphine (0.1 g) to methylhexahydrophthalic anhydride (2.2 g, MHHPA) and the suspension heated to dissolve the catalyst. The FCS or capped FCS was added and the mixture warmed to suspend the FCS. Samples were cured at 150-170° C. for 3 hours. Properties of the cured specimens are shown in Table 11.

TABLE 10

| | | | | Fused | |
|---|---|---|---|---|---|
| Run | | | Catalyst | silica | |
| # | Resin (g)* | MHHPA (g) | (g) | (g) | Comment |
| 39 | UVR6105 | 2.2 | Al (acac)3 | 2.3 | Viscosity stable |
| | (2.52) | | 0.1 | | overnight, forms |
| | | | | | opaque film on |
| | | | | | curing |
| 40 | UVR6105 | 2.2 | TPP** 0.1 | 2.3 | Viscosity stable |
| | (2.52) | | | | overnight, forms |
| | | | | | opaque film on |
| | | | | | curing |
| 41 | Run 20 | 2.2 | Al (acac)3 | | Resin spontaneously |
| | (5.6) | | 0.1 | | cures |
| 42 | Run 20 | 2.2 | TPP** 0.1 | | Resin slowly cures |
| | (5.60) | | | | overnight |
| 43 | Run 27 | 2.2 | Al (acac)3 | | Viscosity stable |
| | (5.41) | | 0.1 | | overnight, forms |
| | | | | | clear film on curing |
| 44 | Run 28 | 2.2 | Al (acac)3 | | Viscosity stable |
| | (5.77) | | 0.1 | | overnight, forms |
| | | | | | clear film on curing |
| 45 | Run 29 | 2.2 | Al (acac)3 | | Viscosity stable |
| | (5.55) | | 0.1 | | overnight, forms |
| | | | | | clear film on curing |

*Amount of resin (Runs 20, 27-29) calculated to provide 2.52 g UVR 6105.
**TPP is triphenylphosphine.

The results of Table 10 indicate that substantial gains in final epoxy formulation stability may be realized by capping the functionalized colloidal silica.

TABLE 11

| Entry# | Material Run# | Tg | CTE below Tg* |
|---|---|---|---|
| 46 | 39 | 180 | 50 |
| 47 | 40 | 165 | 50 |
| 48 | 42 | 155 | 50 |
| 49 | 43 | 145 | 55 |
| 50 | 44 | 143 | 50 |
| 51 | 45 | 157 | 54 |

*PPM/° C. Base resin for entry 1 showed a CTE of 70-75 ppm/° C.

### Example 9

### Preparation of Total Curable Epoxy Formulation

A blend of functionalized colloidal silica epoxy resin was blended with UV9392C [(4-Octyloxypheny)phenyliodonium hexafluoroantimonate from GE Silicones] and benzopinacole from Aldrich in Speed Mixer DAC40OFV from Hauschild Company (Table 12). The resulting liquid to semi solid resin was stored below 5° C. The resulting resins were cured at 130° C. for 20 min and postcure at 175° C. for 2 hours.

TABLE 12

| | Run number | | | | | | |
|---|---|---|---|---|---|---|---|
| | 52 | 53 | 54 | 55 | 56 | 57 | 58 |
| Composition/pph | | | | | | | |
| FB-5LDX | 59.6 | 0 | 0 | 0 | 0 | 0 | 0 |
| UVR6105 | 39.8 | 98.5 | 0 | 0 | 0 | 0 | 0 |
| Resin Type/Run | 0 | 0 | 19 | 20 | 21 | 22 | 23 |
| Resin amount | 0 | 0 | 98.5 | 98.5 | 98.5 | 98.5 | 98.5 |
| UV9392C | 0.4 | 1 | 1 | 1 | 1 | 1 | 1 |
| Benzopinacol | 0.2 | 0.5 | 0.5 | 0.5 | 0.5 | 0.5 | 0.5 |
| Carbon Black | 0 | 0 | 0 | 0 | 0 | 0 | 0 |
| Candelilla Wax | 0 | 0 | 0 | 0 | 0 | 0 | 0 |
| Properties | | | | | | | |
| Spiral Flow | ND | ND | ND | ND | ND | ND | ND |
| CTE (ppm/° C.) | 36.8 | 70 | 46 | 41.6 | 41 | 38.4 | 36.7 |
| Appearance | NT | T | T | T | T | T | T |

FB-5LDX - fused silica - Denka Corporation
UVR6105 - cycloaliphatic epoxy resin - Dow Chemicals
UV9392C - (octyloxyphenyl)phenyliodonium hexafluoro antimonate - GE Silicones
NT—not transparent
T—transparent

The data of Table 12 demonstrate that improvements in CTE may be obtained by use of a combination of fused colloidal silica and colloidal silica.

### Example 10

### Preparation of Molding Compound

Fused silica FB-5LDX from Denka Corporation was blended with functionalized colloidal silica epoxy resin in Speed Mixer DAC40OFV from Hauschild Company. The resulting paste was blended with (4-Octyloxypheny)phenyliodonium hexafluoroantimonate from GE Silicones and benzopinacole from Aldrich, carbon black and candelilla wax using the same Mixer. The resulting molding compound was stored below 5° C.

TABLE 13

| | Run number | | | | | | | | |
|---|---|---|---|---|---|---|---|---|---|
| | 59 | 60 | 61 | 62 | 63 | 64 | 65 | 66 | 67 |
| Composition/pph | | | | | | | | | |
| FB-5LDX | 79.8 | 84.85 | 89.9 | 79.8 | 79.8 | 79.5 | 0 | 0 | 0 |
| UVR6105 | 19.9 | 14.925 | 9.95 | 0 | 0 | 0 | 0 | 0 | 0 |
| Resin Type/Run | 0 | 0 | 0 | 7 | 9 | 7 | 30 | 37 | 38 |
| Resin amount 0 | 0 | 0 | 19.9 | 19.9 | 19.7 | 98.5 | 98.5 | 98.5 | |
| UV9392C | 0.2 | 0.15 | 0.1 | 0.2 | 0.2 | 0.2 | 0.2 | 0.2 | 0.2 |
| Benzopinacol | 0.1 | 0.075 | 0.05 | 0.1 | 0.1 | 0.1 | 0.1 | 0.1 | 0.1 |
| Carbon Black | 0 | 0 | 0 | 0 | 0 | 0.2 | 0.2 | 0.2 | 0.2 |
| Candelilla Wax | 0 | 0 | 0 | 0 | 0 | 0.2 | 0.2 | 0.2 | 0.2 |
| Properties | | | | | | | | | |
| Spiral Flow | TLV | 18 | DNF | 36 | 33.5 | ND | ND | ND | ND |
| CTE (ppm/° C.) | 16.4 | 12.6 | 10.5 | 10.5 | 10 | 12.3 | 12.2 | 12.7 | 12.3 |

FB-5LDX - fused silica - Denka Corporation
UVR6105 - cycloaliphatic epoxy resin - Dow Chemicals
UV9392C - (octyloxyphenyl)phenyliodonium hexafluoro antimonate - GE Silicones
DNF - can not transfer mold - due to lack of flow
TLV - can not transfer mold due to too low viscosity

The results of Table 13 demonstrate the beneficial combination of improved flow and reduced CTE obtained for the samples containing colloidal silica.

### Example 11

### Compression Molding

Flex-bars for CTE measurements were prepared by a compression molding using Tetrahedron pneumatic press. Typical molding conditions: Molding temperature—350° C.; Molding pressure—10000 psi; Molding time—15 min

### Example 12

### Transfer Molding

Spiral flow experiments were done using a transfer molding press Gluco E5 manufacture by Tannewits-Ramco-Gluco. Clamp forces of 5 tons at an operating pressure of 100 psi. Maximum plunger force—1200 psi.

Typical cure conditions are: Plunger pressure—660 psi; Plunger time—25 sec; Clamp time—100 sec; Clamp force—5 tons; Mold—standard spiral flow mold.

TABLE 14

| | Run number | | | | |
|---|---|---|---|---|---|
| | 68 | 69 | 70 | 71 | 72 |
| Composition/pph | | | | | |
| FB-5LDX | 74.34 | 74.34 | 84.575 | 84.575 | 79.5 |
| UVR6105 | | | | 0 | 0 |
| Resin Type/Run | 30 | 36 | 30 | 36 | 33 |
| Resin amount | 24.785 | 24.785 | 14.9 | 14.9 | 19.7 |
| UV9392C | 0.25 | 0.25 | 0.15 | 0.15 | 0.2 |
| Benzopinacol | 0.125 | 0.125 | 0.075 | 0.075 | 0.1 |
| Carbon Black | 0.25 | 0.25 | 0.15 | 0.15 | 0.2 |
| Candelilla Wax | 0.25 | 0.25 | 0.15 | 0.15 | 0.2 |
| Properties | | | | | |
| Spiral Flow | TLV | 37 | DNF | 1 | 36 |
| CTE (ppm/° C.) | 16 | 14.1 | 8.7 | 8.2 | 12.7 |

FB-5LDX - fused silica - Denka Corporation
UVR6105 - cycloaliphatic epoxy resin - Dow Chemicals
DNF - can not transfer mold - due to lack of flow
TLV - can not transfer mold - due to too low viscosity

TLV—can not transfer mold—due to too low viscosity

### Example 13

### Evaluation of CTE

CTE for molded bars was measured using Perkin Elmer Thermo-mechanical Analyzer TMA7 in the temperature range from 10° C. to 260° C. at a heating rate of 10 deg/min.

While embodiments have been shown and described, various modifications and substitutions may be made thereto without departing from the spirit and the scope of the invention. Accordingly, it is to be understood that the present invention has been described by way of illustration and not limitation.

What is claimed is:

1 A composition comprising functionalized colloidal silica wherein the colloidal silica is functionalized with at least one organoalkoxysilane functionalization agent and subsequently functionalized with at least one capping agent.

2 The composition in accordance with claim 1, wherein the organoalkoxysilane comprises phenyltrimethoxysilane.

3 The composition in accordance with claim 1, wherein the capping agent comprises a silylating agent.

4 The composition in accordance with claim 3, wherein the silylating agent comprises hexamethyldisilazane.

5 The composition in accordance with claim 1, wherein at least 10% of free hydroxyl groups on the functionalized colloidal silica are capped.

6 The composition in accordance with claim 1, wherein at least 20% of free hydroxyl groups on the functionalized colloidal silica are capped.

7 The composition in accordance with claim 1, wherein at least 35% of free hydroxyl groups on the functionalized colloidal silica are capped.

8 A composition comprising functionalized colloidal silica wherein the colloidal silica is functionalized with phenyltrimethoxysilane and subsequently functionalized with hexamethyldisilazane.

9 An organic dispersion of colloidal silica comprising colloidal silica in the presence of at least one organoalkoxysilane functionalization agent, at least one capping agent, and at least one epoxy monomer.

10 The dispersion in accordance with claim 9, wherein the organoalkoxysilane functionalization agent comprises phenyltrimethoxysilane.

11 The dispersion in accordance with claim 9, wherein the capping agent comprises a silylating agent.

12 The dispersion in accordance with claim 11, wherein the silylating agent comprises hexamethyldisilazane.

13 The dispersion in accordance with claim 9, wherein the epoxy monomer comprises a cycloaliphatic epoxy monomer, an aliphatic epoxy monomer, an aromatic epoxy monomer, a silicone epoxy monomer, or combinations thereof.

14 The dispersion in accordance with claim 9, wherein at least 10% of free hydroxyl groups on the functionalized colloidal silica are capped.

15 The dispersion in accordance with claim 9, wherein at least 20% of free hydroxyl groups on the functionalized colloidal silica are capped.

16 The dispersion in accordance with claim 9, wherein at least 35% of free hydroxyl groups on the functionalized colloidal silica are capped.

17 An organic dispersion of colloidal silica comprising colloidal silica in the presence of phenyltrimethoxysilane, hexamethyldisilazane, and at least one epoxy monomer.

18 A method for making a colloidal silica dispersion comprising
(A) functionalizing colloidal silica with at least one organoalkoxysilane functionalization agent in the presence of aliphatic alcohol to form a pre-dispersion;
(B) adding at least one curable epoxy monomer and optionally additional aliphatic solvent to the pre-dispersion to form a final dispersion;
(D) at least partially removing any low boiling components from the pre-dispersion or final dispersion;
(E) subsequently adding an effective amount of at least one capping agent; and
(F) substantially removing any low boiling components to form a final concentrated dispersion.

19 The method in accordance with claim 18, wherein the capping agent is added to the pre-dispersion.

20 The method in accordance with claim 18, wherein the capping agent is added to the final dispersion.

21 The method in accordance with claim 18, wherein the at least one capping agent comprises a silylating agent.

22 The method in accordance with claim 21, wherein the silylating agent comprises hexamethyldisilazane.

23 The method in accordance with claim 18, wherein the organoalkoxysilane comprises phenyltrimethoxysilane.

24 The method in accordance with claim 18, wherein the aliphatic alcohol comprises isopropanol, t-butanol, 2-butanol, or combinations thereof.

25 The method in accordance with claim 18, wherein the capping agent caps at least 10% of free hydroxyl groups on the functionalized colloidal silica.

26 The method in accordance with claim 18, wherein the capping agent caps at least 20% of free hydroxyl groups on the functionalized colloidal silica.

27 The method in accordance with claim 18, wherein the capping agent caps at least 35% of free hydroxyl groups on the functionalized colloidal silica.

28 A method for making a colloidal silica dispersion comprising
(A) functionalizing colloidal silica with phenyltrimethoxysilane functionalization agent in the presence of isopropanol to form a pre-dispersion;
(B) at least partially removing the isopropanol from the pre-dispersion;
(C) subsequently adding an effective amount of hexamethyldisilazane to the pre-dispersion; and
(D) adding at least one epoxy monomer to form a final dispersion; and
(E) substantially removing any low boiling components to form a final concentrated dispersion.

29 A method for making a colloidal silica dispersion comprising
(A) functionalizing colloidal silica with phenyltrimethoxysilane functionalization agent in the presence of isopropanol to form a pre-dispersion;
(B) adding at least one epoxy monomer to the pre-dispersion to form a final dispersion;
(C) at least partially removing the isopropanol from the final dispersion;
(D) subsequently adding an effective amount of hexamethyldisilazane; and
(E) substantially removing any low boiling components to form a final concentrated dispersion.
